(19) United States
(12) Patent Application Publication
(10) Pub. No.: US 2009/0140958 A1
(43) Pub. Date: Jun. 4, 2009

(54) INFORMATION PROCESSING APPARATUS

(75) Inventor: Yoshiaki OTAKI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/276,763

(22) Filed: Nov. 24, 2008

(30) Foreign Application Priority Data
Nov. 30, 2007 (JP) P2007-310858

(51) Int. Cl. G09G 3/30; G06F 17/00

(52) U.S. Cl. 345/76; 715/273

(57) ABSTRACT

An information processing apparatus includes a main display composed of an organic electronic luminescent including a light emitting layer and configured to display at least one instruction information in a first display area of a standby screen, and a control unit configured to perform such a control that an illumination time taken for transiting a lighting state of the main display from a first state to a second state is set, whether the illumination time elapses after the lighting state is set in the first state is determined, and when determined that the illumination time elapses after the lighting state is set in the first state, the lighting state is set from the first state to the second state, and in synchronism with this transition to the second state, the display of the instruction information displayed in the first display area on the main display is deleted.

### BACKGROUND OF THE INVENTION

1. Field of the Invention

The present invention relates to an information processing apparatus. In particular, the invention relates to an information processing apparatus such as a cellular phone which uses organic electro luminescent for a display.

2. Description of the Related Art

Recently, among various electronic devices such as a cellular phone, a PDA (Personal Digital Assistant), and a digital camera, a display using organic electro luminescent have been proposed instead of using a TFT (Thin Film Transistor) liquid crystal display which was a mainstream display in the past. An organic EL (Electronic Luminescent) display utilizes an organic material which emits light when being applied with a voltage. In this organic EL, for example, an organic substance such as diamines is vapor-deposited on a glass surface, and the organic substance itself emits light. For that reason, the thickness of the display can be made thinner as compared with a case in a related art.

In the display using the organic EL, it is possible to obtain a clear screen display with a high luminance. On the other hand, due to the configuration in which a light emitting layer of the organic EL itself emits light, if the same image is continuously displayed at the same position in the screen, along with the repetition of the light emission, an excitation state of the light emitting layer which constitutes pixels included in the image area is gradually decreased, and these pixels are degraded.

In particular, in the case of the cellular phone, the display area is generally provided in a top position of a screen such as a standby screen for displaying icons related to the field intensity and the battery remaining amount. These icons related to the field intensity and the battery remaining amount displayed are regularly displayed in this display area. For that reason, the pixels included in the display area where the icons related to the field intensity and the battery remaining amount are displayed are degraded more easily as compared with pixels in other display areas.

In view of the above, for the cellular phone to which the display using the organic EL is mounted, such a technology is proposed that the icons related to the field intensity and the battery remaining amount are displayed in a predetermined display area, and after a predetermined period of time elapses, the display of these icons is deleted.

According to Japanese Unexamined Patent Application Publication No. 2003-198665, a technology with which a user can be notified of an occurrence of an event to be processed in a background is proposed as a technology related to the display control of the icons on the display screen, for example.

Incidentally, in recent cellular phones, without a limitation to the cellular phone to which the display using the organic EL is mounted, the following control is carried out related to a lighting state of the display That is, the control is carried out so that the lighting state is transited from a state in which the lighting state of the display is bright (hereinafter, referred to as “full lighting state”) to a state in which the lighting state is set darker than the full lighting state but characters and icons on the display are recognizable (hereinafter, referred to as “partial state”) when a predetermined time set in advance elapses since the user stops operating the cellular phone in the full lighting state. Then, the lighting state is further transited to a state in which displaying is not performed on the display when a predetermined time set in advance elapses since the user stops operating the cellular phone in the partial state(hereinafter, referred to as “lights-out state”).

However, in the cellular phone in the related art to which the display using the organic EL is mounted, a deletion timing for the icons related to the field intensity and the battery remaining amount and a transition timing regarding the lighting state of the display are unconnectedly controlled. Thus, in some cases, even when the lighting state of the display is the full lighting state, the icons related to the field intensity and the battery remaining amount are deleted due to the elapse of time. In such a case, the user cannot check the field intensity and the battery remaining amount and there is a problem that ease of use is not satisfactory to the user.

### SUMMARY OF THE INVENTION

The present invention to provide has been made in view of the above-mentioned situation, and it is an object of the invention to provide an information processing apparatus such as a cellular phone in which while degradation of a display using organic EL is suppressed, it is possible to improve usability.

In order to solve the above-mentioned problem, according to an aspect of the present invention, there is provided an information processing apparatus, including; a display unit which is configured by an organic electronic luminescent at least including a light emitting layer and configured to display one instruction information in a first display area of a standby screen; a setting unit configured to set an illumination time which is a time taken for setting a lighting state of the display unit from a first state to a second state; a determination unit configured to determine whether the illumination time set by the setting unit elapses after the lighting state of the display unit is set in the first state; and a display control unit configured to set the lighting state of the display unit from the first state to the second state and control to delete the display of the instruction information displayed in the first display area by the display unit in a case where the determination unit determines that the illumination time set by the setting unit elapses after the lighting state of the display unit is set in the first state.

According to the aspect of the present invention, while the degradation of the display using the organic EL is suppressed, it is possible to improve the usability.

### BRIEF DESCRIPTION OF THE DRAWINGS

FIGS. 1A and 1B illustrate external appearance configurations of a cellular phone which can be applied to an information processing apparatus according to an embodiment of the present invention;

FIGS. 2A and 2B illustrate other external appearance configurations of the cellular phone which can be applied to the information processing apparatus according to the embodiment of the present invention;

FIG. 3 is a block diagram of an internal configuration of the cellular phone which can be applied to the information processing apparatus according to the embodiment of the present invention;

FIG. 4 is a flowchart for describing an illumination time setting processing in the cellular phone in FIG. 3;

FIG. 5 is a transition diagram of a display screen displayed in a main screen in FIG. 3 at the time of the illumination time setting processing;

FIG. 6 is a flowchart for describing a display control processing in the cellular phone in FIG. 3;

FIG. 7 is a transition diagram of a display screen displayed in the main screen in FIG. 3 at the time of the display control processing;

FIG. 8 is a flowchart for describing another illumination time setting processing in the cellular phone in FIG. 3;

FIG. 9 is a flowchart for describing another illumination time setting processing in the cellular phone in FIG. 3;

FIG. 10 is a flowchart for describing another illumination time setting processing in the cellular phone in FIG. 3; and

FIG. 11 is a flowchart for describing another illumination time setting processing in the cellular phone in FIG. 3.

### DESCRIPTION OF THE PREFERRED EMBODIMENTS

Hereinafter, embodiments of the present invention will be described with reference to the drawings.

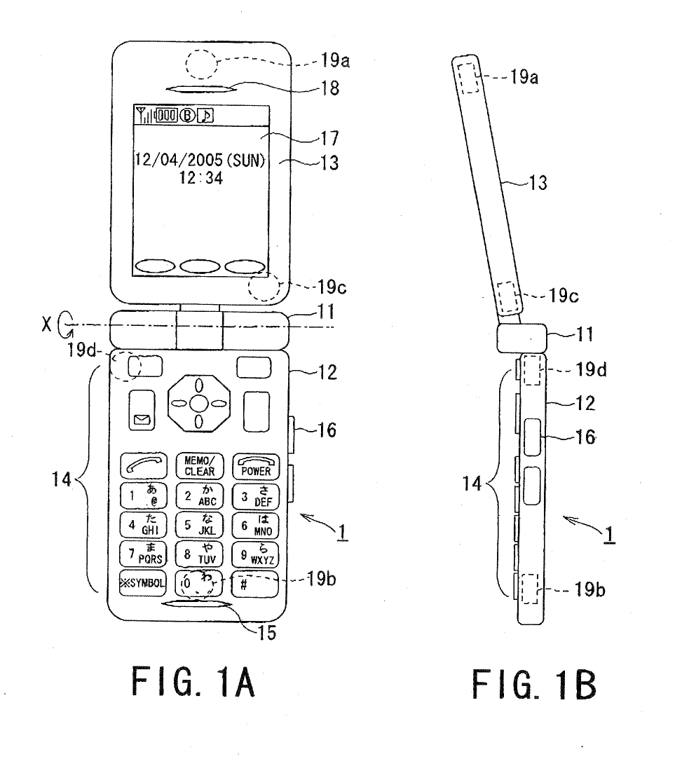

FIGS. 1A and 1B illustrate external appearance configurations of a cellular phone 1 which can be applied to an information processing apparatus according to an embodiment of the present invention. Specifically, FIG. 1A and FIG. 1B are a front external view and a side external view, respectively, of the cellular phone 1 opened about 180 degrees.

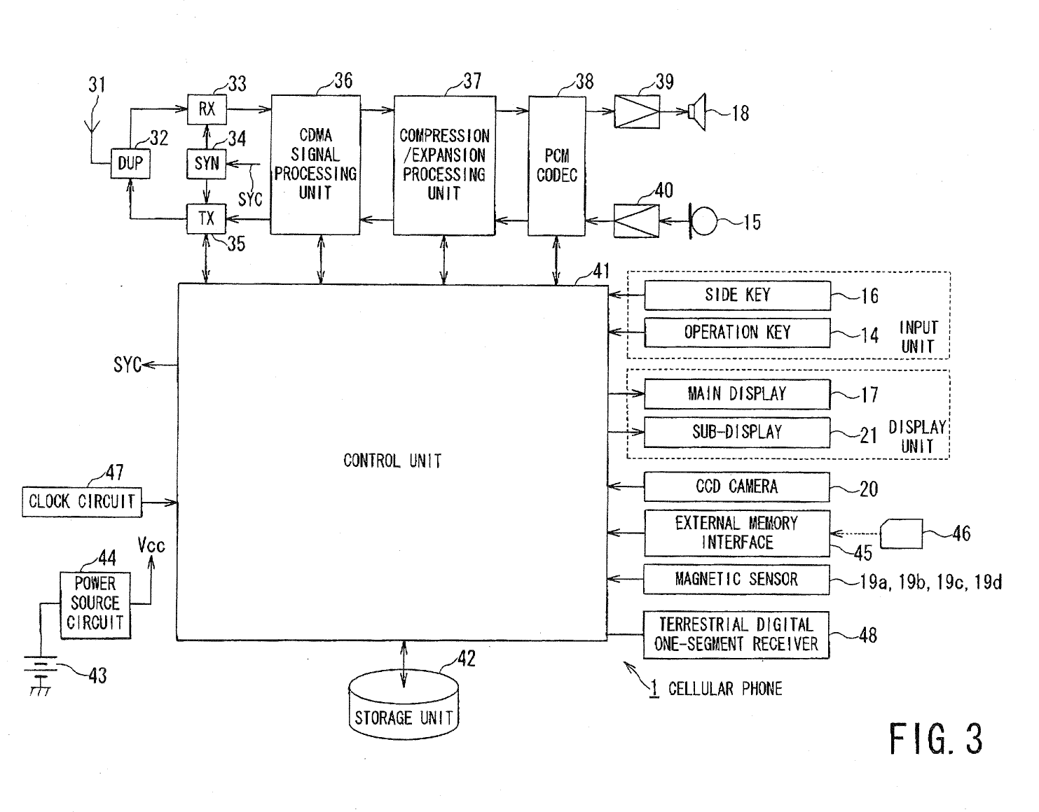

As illustrated in FIGS. 1A and 1B, the cellular phone 1 includes a first casing 12 and a second casing 13 which are hinge-connected to each other with a hinge part 11 in the middle. The cellular phone 1 is formed so as to be foldable in an arrow X direction via the hinge part 11. An antenna for transmission and reception (an antenna 31 in FIG. 3 described below) is provided at a predetermined location inside the cellular phone 1. The cellular phone 1 may transmit and receive radio waves with a base station (not shown) via this internal antenna.

The first casing 12 is provided with operation keys 14 on its surface, such as alphanumeral keys from “0” to “9”, an outgoing call key, a redial key, a power key, a clear key, and an electronic mail key (e-mail key). It is possible to input various instructions by using the operation keys 14. The operation keys 14 includes a cross key and an confirmation key located in an upper part of the first housing 12. By operating the cross key from side to side and up and down, the user can move a displayed cursor from side to side and up and down. Specifically, various operations, such as scrolling of an address book list, e-mail messages, simplified homepages, and various images displayed on a main display 17 in the second housing 13, are performed.

Pressing the confirmation key allows the user to confirm various functions. For example, when a desired phone number is selected from a plurality of phone numbers on the address book list displayed on the main display 17 according to the user's operation of the cross key, and then, the confirmation key is pressed toward the interior of the first housing 12, the selected phone number is confirmed and an outgoing call processing is performed for the telephone number.

The first housing 12 also has the e-mail key located to the left of the cross key and the confirmation key. When the e-mail key is pressed toward the interior of the first housing 12, e-mail transmission and reception functions are called. The browser key is provided to the right of the cross key and the confirmation key. Pressing the browser key toward the interior of the first housing 12 allows the user to view data on Web pages.

The first housing 12 has a microphone 15 located under the operation keys 14. The microphone 15 collects user's voice during a call. The first housing 12 also has a side key 16 for operating the cellular phone 1.

A battery pack is inserted to be attached on a back surface of the first casing 12. When the power key is turned on, power supplied from the battery pack actuates each circuit.

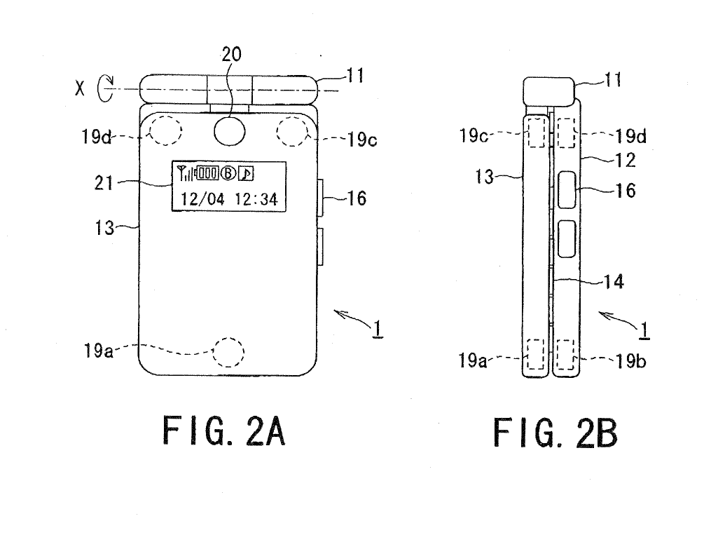

The second housing 13 has the main display 17 on its front surface. The main display 17 displays a reception state of the radio wave, a remaining battery level, destination names and phone numbers registered in the address book, a transmission history, content of e-mail messages, simplified homepages, images picked up by a charge-coupled device (CCD) camera (a CCD camera 20 of FIG. 2 described below), content received from an external content server, and content stored in a memory card (a memory card 46 of FIG. 3 described below) A telephone receiver (earpiece) 18 is provided at a predetermined position above the main display 17. The telephone receiver 18 allows the user to make a voice call. Besides the telephone receiver 18, a speaker serving as a voice output unit is provided at a predetermined position in the cellular phone 1.

Magnetic sensors 19a, 19b, 19c, and 19d for detecting the state of the cellular phone 1 are provided at predetermined positions inside the first casing 12 and the second casing 13. It should be noted that the main display 17 is a display configured by using organic EL.

FIGS. 2A and 2B illustrate other external appearance configurations of the cellular phone 1 which can be applied to the information processing apparatus according to the embodiment of the present invention. The second housing 13 at the position illustrated in FIG. 1A and FIG. 1B pivots in the direction of arrow X to the position illustrated in FIG. 2A and FIG. 2B. FIG. 2A and FIG. 2B are a front external view and a side external view, respectively, of the cellular phone 1 in a closed state. The CCD camera 20 is provided at an upper part of the second casing 13. The CCD camera 20 allows the user to pick up an image of a desired target. The sub-display 21 is provided under the CCD camera 20. The sub-display 21 displays an antenna pictogram indicating a current sensitivity level of the antenna, a battery pictogram indicating a current remaining battery level of the cellular phone 1, and current time.

FIG. 3 illustrates an internal configuration of the cellular phone 1. A radio signal transmitted from the base station is received by the antenna 31, passes through an antenna duplexer (DUP) 32, and is input to a receiver (RX) 33. The receiver 33 may perform mixing of the received radio signal with a local oscillation signal output from a frequency synthesizer (SYN) 34 to down-convert the received radio signal into an intermediate frequency signal. Then, the receiver 33 generates a reception baseband signal by performing a quadrature demodulation (quadrature detection) on the down-converted intermediate frequency signal. The receiver 33 outputs the generated baseband signal to a CDMA signal processor 36. The frequency of the local oscillation signal generated from the frequency synthesizer 34 is indicated by a control signal SYC output from a controller 41.

The CDMA signal processor 36 is provided with a RAKE receiver. In the RAKE receiver, a plurality of paths included in the reception baseband signal are de-spread with respective spread codes (i.e., spread codes equivalent to those of the spread reception signals). Then, after the phase in the despread signals of the respective paths is adjusted, the despread signals of the respective paths are coherently RAKE-combined by the RAKE receiver. A data series obtained through the Rake combining is subjected to de-interleaving, channel decoding (error correction decoding), and binary data determination. Thus, reception packet data in a predetermined transmission format can be obtained. The reception packet data is input to a compression/decompression processor 37.

The compression/decompression processor 37 is composed of a digital signal processor (DSP). The compression/decompression processor 37 separates the reception packet data output from the CDMA signal processor 36 in a multiplexer/demultiplexer for each media, and perform a decoding processing on the separated data for each media. For example, in a call mode, speech data included in the reception packet data and corresponding to spoken voice is decoded by a speech codec. If video data is included in the reception packet data, such as in the case of a videophone mode, the video data is decoded by a video codec. For example, if the reception packet data is downloaded content, the downloaded content is decompressed (expanded) and output to the controller 41.

A digital speech signal obtained by decoding is supplied to a PCM codec 38. The PCM codec 38 PCM-decodes the digital speech signal output from the compression/decompression processor 37, and outputs an analog speech signal obtained by the PCM decoding to a receiving amplifier 39. The analog speech signal is amplified by the receiving amplifier 39 and output by the telephone receiver 18.

A digital video signal obtained through decoding performed by the compression/decompression processor 37 at the video codec is input to the controller 41. The controller 41 causes the main display 17 to display, via a video RAM such as a VRAM, a video image based on the digital video signal output from the compression/decompression processor 37. The controller 41 causes the main display 17 to display, via the RAM, not only a received video data but also a video data picked up by the CCD camera 20,

If the reception packet data is an e-mail message, the compression/decompression processor 37 supplies the e-mail message to the controller 41. The controller 41 causes a storage unit 42 to store the e-mail message supplied from the compression/decompression processor 37. Then, in response to the user's operation of the operation keys 14 included in an input unit, the controller 41 reads the e-mail message stored in the storage unit 42 and causes the main display 17 to display the read e-mail message.

On the other hand, in the call mode, a speaker's (user's) speech signal (analog speech signal) input to the microphone 15 is amplified to a proper level by a transmitting amplifier 40 and PCM-coded by the PCM codec 38. A digital speech signal obtained by the PCM coding is input to the compression/decompression processor 37. A video signal output from the CCD camera 20 is digitized by the controller 41 and input to the compression/decompression processor 37. An e-mail message, which is text data generated by the controller 41, is also input to the compression/decompression processor 37.

The compression/decompression processor 37 may compression-code the digital speech signal from the PCM codec 38 in a format corresponding to a predetermined transmission data rate. Thus, speech data is generated. Also, the compression/decompression processor 37 compression-codes the digital video signal from the controller 41 so as to generate video data. Then, the compression/decompression processor 37 causes the multiplexer/demultiplexer to multiplex the speech data and the video data into transmission packet data in accordance with a predetermined transmission format. The compression/decompression processor 37 packetizes the data multiplexed in the multiplexer/demultiplexer. The compression/decompression processor 37 outputs the transmission packet data after the packetization to the CDMA signal processor 36. When an e-mail message is output from the controller 41, the compression/decompression processor 37 similarly causes the multiplexer/demultiplexer to multiplex the e-mail message into transmission packet data.

The CDMA signal processor 36 uses a spread code assigned to a transmission channel to perform spread spectrum processing on the transmission packet data output from the compression/decompression processor 37, and outputs an output signal generated by the spread spectrum processing to a transmitter (TX) 35. The transmitter 35 modulates the signal after the spread spectrum processing by using a digital modulation method such as a QPSK (Quadrature Phase Shift Keying) method. The transmitter 35 synthesizes the transmission signal after the digital modulation with the local oscillator signal generated from the frequency synthesizer 34 to up-convert the transmission signal into the radio signal Then, the transmitter 35 high-frequency-amplifies the radio signal generated by the up-conversion so as to obtain the transmission power level indicated by the controller 41. The high-frequency-amplified radio signal is supplied via the antenna duplexer 32 to the antenna 31, and is transmitted from the antenna 31 to the base station.

The cellular phone 1 has an external memory interface 45, which has a slot allowing insertion and withdrawal of the memory card 46. The memory card 46 is a type of flash memory card typified by a NAND flash memory card and a NOR flash memory card. Various types of data, such as images, speech, and music can be written to and read from the memory card 46 via a 10-pin terminal. The cellular phone 1 further has a clock circuit (timer) 47 for accurate measurement of the current time. Also, a terrestrial digital one-segment receiver 48 receives the terrestrial digital one-segment broadcast wave transmitted from a broadcasting station.

The controller 41 includes a central processing unit (CPU), a read only memory (ROM), and a random access memory (RAM). The CPU performs various types of processing according to a program stored in the ROM or various application programs loaded from the storage unit 42 to the RAM, generates various control signals, supplies the control signals to various sections, and thus controls the overall operation of the cellular phone 1. The RAM stores data necessary for the CPU to perform various types of processing.

The storage unit 42 is composed of a hard disk drive (HDD) or a flash memory device, which is a nonvolatile memory allowing electrical writing and erasing. The storage unit 42 stores various data groups and various application programs to be executed by the CPU in the controller 41. A power circuit 44 generates a predetermined operating supply voltage Vcc on the basis of an output from a battery 43 and supplies the operating supply voltage Vcc to each circuit unit.

Incidentally, in recent cellular phones, without a limitation to the cellular phone 1 to which the display using the organic EL is mounted, the following control is carried out related to a lighting state of the display. That is, the control is carried out so that the lighting state is transited from a state in which the lighting state of the display is bright (hereinafter, referred to as “full lighting state”) to a state in which the lighting state is set darker than the full lighting state but characters and icons on the display are recognizable (hereinafter, referred to as “partial state”) when a predetermined time set in advance elapses since the user stops operating the cellular phone in the full lighting state, and further transited to a state in which displaying is not performed on the display when a predetermined time set in advance elapses since the user stops operating the cellular phone in the partial state (hereinafter, referred to as “lights-out state”).

However, in the cellular phone in the related art to which the display using the organic EL is mounted, a deletion timing for the icons related to the field intensity and the battery remaining amount and a transition timing regarding the lighting state of the display are unconnectedly controlled. Thus, in some cases, even when the lighting state of the display is the full lighting state, the icons related to the field intensity and the battery remaining amount are deleted due to the elapse of time. In such a case, the user cannot check the field intensity and the battery remaining amount and there is a problem that the ease of use is not satisfactory to the user.

In view of the above, the deleting timing for the icons related to the field intensity and the battery remaining amount and the transiton timing for the lighting state of the display (the main display 17 and the sub-display 21) are synchronized with each other. For example, in conjunction with the timing at which the lighting state of the display (the main display 17 and the sub-display 21) is transited to the partial state, the icons related to the field intensity and the battery remaining amount are deleted. With this configuration, the user can check the icons related to the field intensity and the battery remaining amount in the full lighting state in which the icons on the screen can be easily checked, and also these icons can be deleted at the same time when the lighting state is transited to the partial state. Therefore, while degradation of the display configured by using the organic EL is suppressed, it is possible to improve the usability. Hereinafter, a description will be given of a display control processing using this method.

First, before the display control processing using this method is described, a description will be given of an illumination time setting processing for setting an illumination time which is taken for the lighting state of the display (the main display 17 and the sub-display 21) to transit from the full lighting state to the partial state.

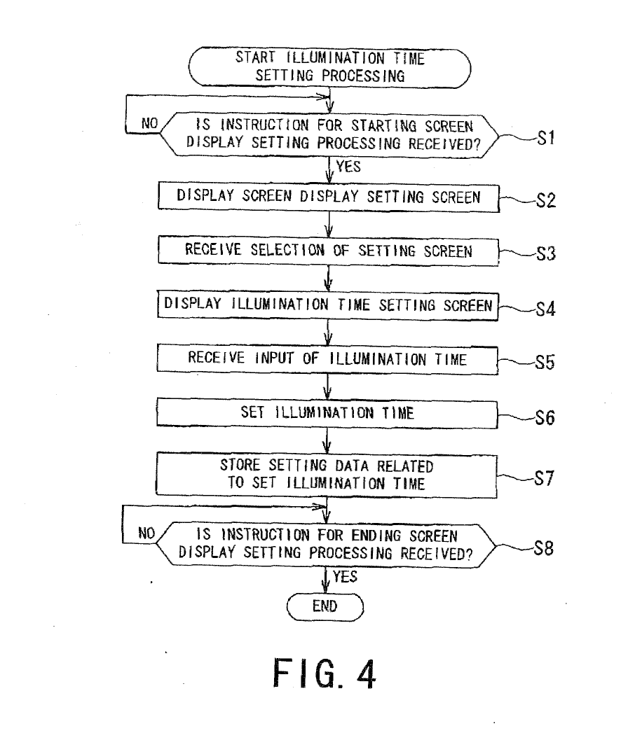

With reference to a flowchart of FIG. 4, the illumination time setting processing in the cellular phone 1 in FIG. 3 will be described. This illumination time setting processing is started when an instruction for starting a screen display setting processing is received as the user operates the operation key 14.

In step S1, the control unit 41 determines whether the instruction for starting the screen display setting processing is received as the user operates the operation key 14. The processing stands by until it is determined that the instruction for starting the screen display setting processing is received as the user operates the operation key 14.

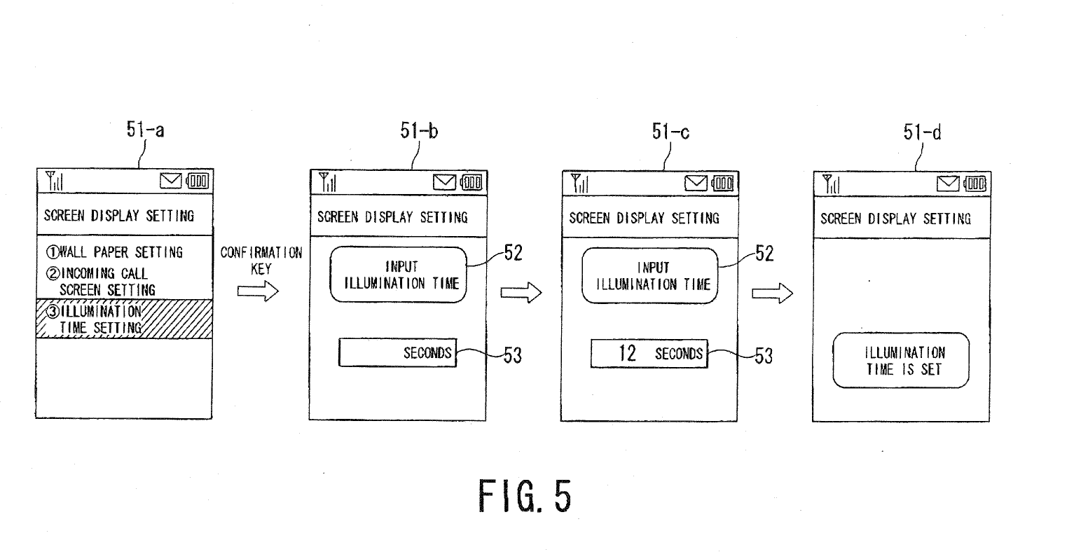

In step S1, in a case where it is determined that the instruction for starting the screen display setting processing is received as the user operates the operation key 14, in step S2, the control unit 41 controls the main display 17 to display a screen display setting screen for performing various settings related to the screen display of the main display 17. As illustrated in FIG. 5, the main display 17 displays a screen display setting screen 51-a, in accordance with the control of the control unit 41. For example, in the case of the screen display setting screen 51-a in FIG. 5, “1. wall paper setting”, “2. incoming call screen setting”, and “3. illumination time setting” are displayed on the screen display setting screen as the settings related to the screen display of the main display 17. At this time, as the user operates a confirm key among the operation keys 14 thereafter, in order to indicate one of the settings related to the screen display of the main display 17, on the screen display setting screen 51-a, one of “1. wall paper setting”, “2. incoming call screen setting”, and “3. illumination time setting” is focused on. In the case of an example in FIG. 5, “3. illumination time setting” is focused on.

In step S3, as the user operates the confirm key among the operation keys 14 the control unit 41 receives the selection of (“1. wall paper setting”, “2. incoming call screen setting”, or “3. illumination time setting”) as one of settings related to the screen display displayed on the main display 17 on the screen display setting screen (the screen display setting screen 51-a).

In step S4, when the control unit 41 receives the selection of “3. illumination time setting” related to the screen display on the screen display setting screen (the screen display setting screen 51-a), in accordance with the selection, the control unit 41 controls the main display 17 to display an illumination time setting screen for setting an illumination time taken for the lighting state of the main display 17 to transit from the full lighting state to the partial state on the main display 17. In accordance with the control of the control unit 41, as illustrated in FIG. 5, the main display 17 displays an illumination time setting screen 51-b.

The illumination time setting screen 51-b of FIG. 5 has a message display column 52 and an input receiving column 53 for receiving an input of the illumination time. In the case of FIG. 5, “input illumination time” is displayed as a message in the message display column 52. With this configuration, the user can understand that it is possible to input the illumination time in this and subsequent processing. Also, it is possible to input the illumination time (for example, a period of time between 0 and 60 seconds) which is a time for the lighting state of the main display 17 to transit from the full lighting state to the partial state in the input receiving column 53.

In step 5, as the user operates the operation key 14, the control unit 41 receives the input of the illumination time on the illumination time setting screen (the illumination time setting screen 51-b). As the user operates the operation key 14, the input of “12 seconds” is received as the illumination time on the illumination time setting screen (the illumination time setting screen 51-b). At this time, the display screen displayed on the main display 17 is transited from the illumination time setting screen 51-b to an illumination time setting screen 51-c.

In step 56, the control unit 41 sets the illumination time which is the time taken for the lighting state of the main display 17 to transit from the full lighting state to the partial state, on the basis of the illumination time whose input has been received. With this configuration, the illumination time which is the time taken for the lighting state of the main display 17 to transit from the full lighting state to the partial state is set as “12 seconds”. Of course, an illumination time other than “12 seconds” may be set.

In step S7, the control unit 41 stores setting data related to the set illumination time in the storage unit 42. The storage unit 42 stores the setting data related to the set illumination time in accordance with the control of the control unit 41. This setting data related to the illumination time includes data indicating that the illumination time which is the time taken for the lighting state of the main display 17 to transit from the full lighting state to the partial state is set as “12 seconds”.

At this time, the display screen displayed on the main display 17 is transited from the illumination time setting screen 51-c to an illumination time setting screen 51-d. On the illumination time setting screen 51-d, a message “illumination time was set” is displayed. With this configuration, it is possible for the user to understand that the illumination time can be set through the previous operations.

In step S8, the control unit 41 determines whether an instruction for ending the screen display setting processing is received as the user operates the operation key 14. The processing stands by until it is determined that the instruction for ending the screen display setting processing is received as the user operates the operation key 14. In step S8, in a case where it is determined that the instruction for ending the screen display setting processing is received, the illumination time setting processing is ended.

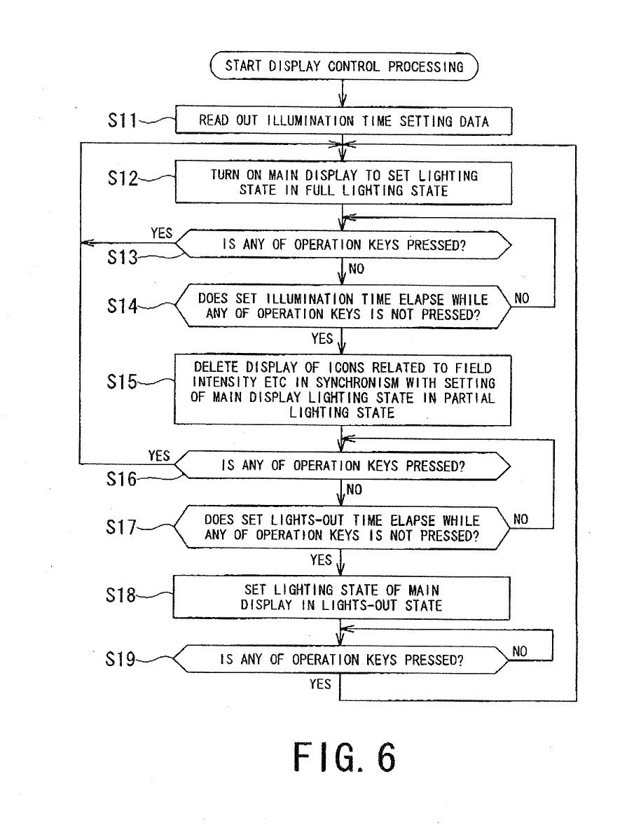

Next, with reference to a flowchart of FIG. 6, a display control processing in the cellular phone 1 in FIG. 3 will be described. It should be noted that in the display control processing described by using the flowchart of FIG. 6, the main display 17 is explicitly described as the display control target, but of course, the sub-display 21 may be applied to the embodiment of the present invention.

In step S11, the control unit 41 reads out the setting data related to the illumination time previously stored in the storage unit 42. This setting data related to the illumination time includes data indicating that the illumination time which is the time taken for the lighting state of the main display 17 to transit from the full lighting state to the partial state is set as “12 seconds”.

In step S12, the control unit 41 controls the main display 17 to turn on the main display 17 to set the lighting state of the main display 17 in the full lighting state. With this configuration, the lighting state of the main display is in the brighter lighting state.

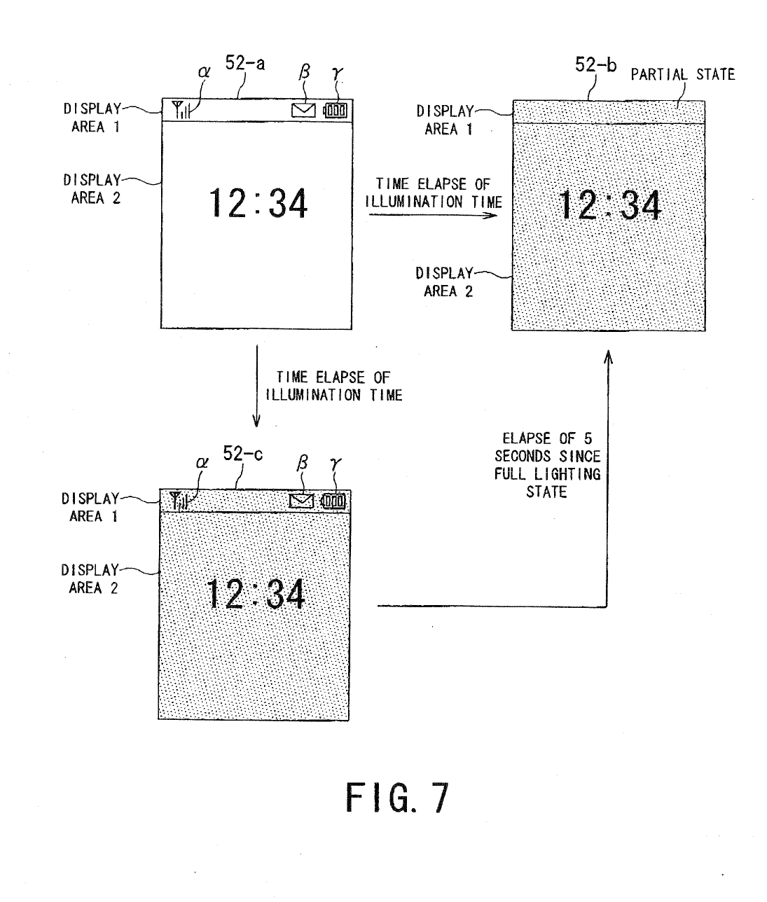

For example, as illustrated in a display screen 52-a of FIG. 7, the lighting state of the main display 17 is set in the full lighting state. In a display area 1 in the display screen of the main display 17, an icon α related to the field intensity by the antenna around the cellular phone 1, an icon β indicating that a mail is received, and an icon γ related to the battery remaining amount of the cellular phone 1 are displayed in the full lighting state. Also, in a display area 2 in the display screen of the main display 17, a character string “12:34” indicating the current time is displayed in the full lighting state.

In step S13, the control unit 41 monitors the operation key 14 to determine whether the user presses any of the operation keys 14. In step S13, in a case where it is determined that the user presses any of the operation keys 14, the process is returned to step S12. In step S12, the lighting state of the main display 17 is kept in the full lighting state.

On the other hand, in step S13, in a case where it is determined that the user does not press any of the operation keys 14, in step S14, by using the clock circuit 47, on the basis of the read illumination time setting data, the control unit 41 determines whether while the user does not press any of the operation keys, the set illumination time (for example, “12 seconds”, etc.) elapses. In step S14, it is determined that the user does not press any of the operation keys but the set illumination time (for example, “12 seconds”, etc.) has not yet elapsed, the processing is returned to step S13, and the processing in step S13 and subsequent steps is executed.

In step S14, it is determined that while the user does not press any of the operation keys, the set illumination time (for example, “12 seconds”, etc.) has elapsed (that is, in a case where the user does not press any of the operation keys until the set illumination time elapses), in step S15, the control unit 41 controls the main display 17 to set the lighting state of the main display 17 from the full lighting state to the partial state. Also, in synchronism with this transition to the partial state, the icons related to the field intensity and the battery remaining amount (the display of the icons) are deleted. With this configuration, the lighting state of the main display 17 is set in a darker lighting state.

For example, as illustrated in a display screen 52-b of FIG. 7, the lighting state of the main display 17 is transited from the full lighting state to the partial state. Also in synchronism with this transition to the partial state, the icon α related to the field intensity, the icon β related to the mail, and the icon γ related to the battery remaining amount (the display of the icons) displayed in the display area 1 in the display screen 52-a of FIG. 7 are deleted.

In step S16, the control unit 41 monitors the operation key 14 to determine whether the user presses any of the operation keys 14. In step S16, in a case where it is determined that the user presses any of the operation keys 14, the process is returned to step S12. In step S12, the lighting state of the main display 17 is transited to the full lighting state.

On the other hand, in step S16, in a case where it is determined that the user does not press any of the operation keys 14, in step S17, by using the clock circuit 47, the control unit 41 determines whether the set lights-out time (for example, “20 seconds”, etc.) elapses while the user does not press any of the operation keys. In step S17, in a case where it is determined that the user does not press any of the operation keys but the set lights-out time (for example, “20 seconds”, etc.) has not yet elapsed, the processing is returned to step S16, and the processing in step S16 and subsequent steps is executed.

In step S17, in a case where it is determined that the user does not press any of the operation keys and the set lights-out time (for example, “20 seconds”, etc.) has elapsed, in step S18, the control unit 41 controls the main display 17 to set the lighting state of the main display 17 from the partial state to the lights-out state. With this configuration, such a state is established that the displaying is not performed on the main display 17.

In step S19, the operation key 14 is monitored to determine whether the user presses any of the operation keys 14. The processing stands by until it is determined that the user presses any of the operation keys 14. With this configuration, until the user presses any of the operation keys 14, the lighting state of the main display 17 is kept in the lights-out state. On the other hand, in step S19, in a case where it is determined that the user presses any of the operation keys, the processing is returned to step S12. The main display 17 is lightened up, and the lighting state of the main display 17 is set in the full lighting state. With this configuration, the lighting state of the main display is in the brighter lighting state.

According to the embodiment of the present invention, the following control can be carried out. That is, the main display 17 is configured by using the organic EL at least including the light emitting layer. In the first display area in the standby screen, at least one piece of instruction information is displayed (the icon α related to the field intensity, the icon β related to the mail, the icon γ related to the battery remaining amount, and the like). The illumination time which is the time taken for setting the lighting state of the main display 17 from the first state (the full lighting state) to the second state (the partial state) is set. The determination is made as to whether the set illumination time elapses after the lighting state of the main display 17 is set in the first state (the full lighting state). In a case where it is determined that the set illumination time elapses after the lighting state of the main display 17 is set in the first state (the full lighting state), the lighting state of the main display is set from the first state (the full lighting state) to the second state (the partial state). Also, in synchronism with this transition to the second state (the partial state), the display of the instruction information displayed in the first display area on the main display is deleted.

With this configuration, such a situation can be avoided that the deletion timing for the icons related to the field intensity and the battery remaining amount and the transition timing for the lighting state of the display (the main display 17 and the sub-display 21) are separately (asynchronously) controlled, and even though the lighting state of the display (the main display 17 and the sub-display 21) is in the full lighting state, the icons related to the field intensity and the battery remaining amount are deleted due to the time elapse. Therefore, it is possible to avoid such a situation that the user cannot check the field intensity and the battery remaining amount In other words, when the lighting state of the display (the main display 17 and the sub-display 21) is in the full lighting state where the user can easily check various information displayed on the screen, the field intensity and the battery remaining amount can be checked with certainty on the basis of the icons related to the field intensity and the battery remaining amount. At the same time, when the lighting state of the display (the main display 17 and the sub-display 21) is transited to the partial state, (the display of) the icons related to the field intensity and the battery remaining amount can be deleted. Therefore, while the degradation of the display configured by using the organic EL (the main display 17 and the sub-display 21) is suppressed, it is possible to improve the usability.

It should be noted that in the display control processing using the flowchart of FIG. 6, when the lighting state of the main display 17 is transited to the partial state, the deletion processing is carried out on the icon α related to the field intensity, the icon β related to the mail, and the icon γ related to the battery remaining amount displayed in the display area 1 of the main display 17. However, the embodiment of the present invention is not limited to the above-mentioned case. For example, the embodiment of the present invention may be applied to various icons including an icon related to a mode of the cellular phone 1 such as a manner mode, an icon related to a use state of Bluetooth or infrared ray, an icon related to a non-contact type IC chip. Also, the icons subjected to the deletion processing are not limited to the icons displayed in the display area on the top stage (the display area 1) in the main display 17, but also include icons displayed in a display area on any stage other than the top stage. In addition to the above, the embodiment of the present invention can be applied to all displays other than the wall paper and the clock displayed on the display screen in the main display 17. It should be noted that icons, pictograms, and the like other than the wall paper and the clock displayed on the display screen in the main display 17 are defined as “instruction information”.

It should be noted that in the illumination time setting processing using the flowchart of FIG. 4, the illumination time is set as “0 seconds” in accordance with a preference of the user, and the lighting state of the main display 17 can be instantly set in the partial state. However, in this case, if (the display of) the icons related to the field intensity and the battery remaining amount is simply deleted in synchronism with the transition to the partial state, the icons related to the field intensity and the battery remaining amount are not displayed regularly. Although such a setting is made in accordance with the intent of the user, this is not preferable in terms of usability. In view of the above, in a case where the illumination time is set as a time shorter than 5 seconds in accordance with the preference of the user, such a control may be carried out that the icons related to the field intensity and the battery remaining amount are not deleted at least for 5 seconds. Hereinafter, a description will be given of a display control processing using this method.

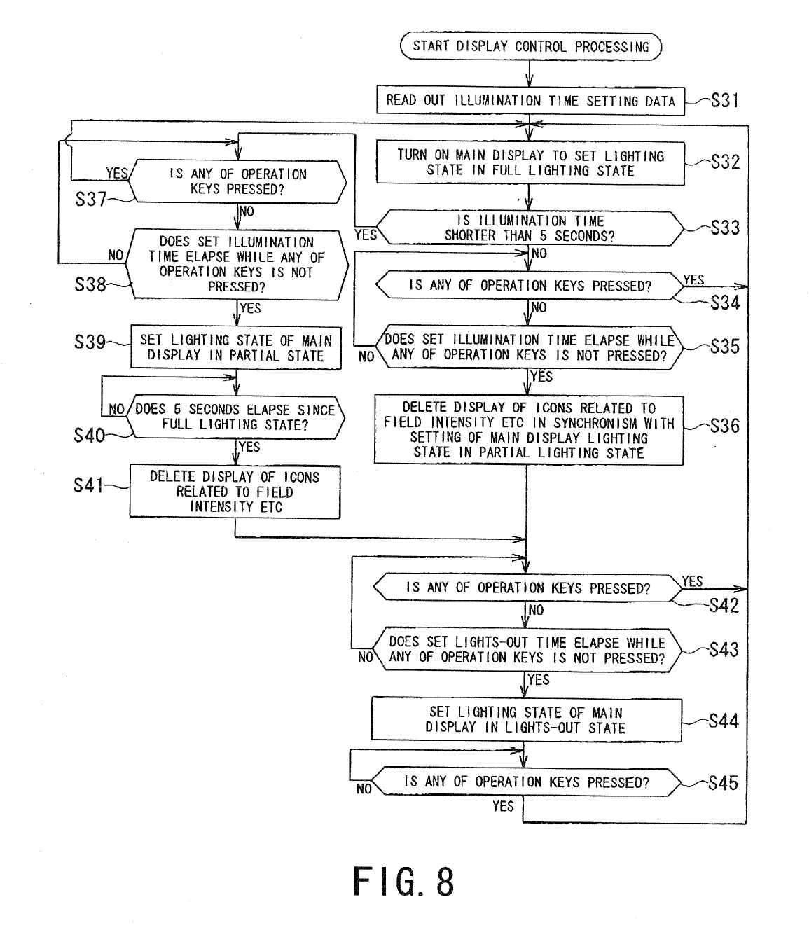

With reference to a flowchart of FIG. 8, another display control processing in the cellular phone 1 in FIG. 3 will be described. It should be noted that the processing in steps S31 and S32, steps S34 to S36, and steps S42 to S45 of FIG. 8 is similar to the processing in steps S11 to S19 of FIG. 6, and a description thereof will be omitted to avoid the repetition.

In step S33, the control unit 41 determines whether the set illumination time is shorter than 5 seconds, on the basis of the read illumination time setting data. In step S33, in a case where it is determined on the basis of the read illumination time setting data that the set illumination time is not shorter than 5 seconds, the processing is advanced to step S34, and the processing in step S34 and subsequent steps are executed.

On the other hand, in step S33, in a case where it is determined on the basis of the read illumination time setting data that the set illumination time is shorter than 5 seconds, in step S37, the control unit 41 monitors the operation key 14 to determine whether the user presses any of the operation keys 14. In step S37, in a case where it is determined that the user presses any of the operation keys 14, the process is returned to step S32. In step S32, the lighting state of the main display 17 is kept in the full lighting state.

On the other hand, in step S37, in a case where it is determined that the user does not press any of the operation keys 14, in step S38, by using the clock circuit 47, on the basis of the read illumination time setting data, the control unit 41 determines whether while the user does not press any of the operation keys, the set illumination time (for example, “12 seconds”, etc.) elapses. In step S38, in a case where it is determined that the user does not press any of the operation keys, but the set illumination time (for example, “12 seconds”, etc.) has not yet elapsed, the process is returned to step S37, and the processing in step S37 and subsequent steps is executed.

In step S38, it is determined that while the user does not press any of the operation keys, the set illumination time (for example, “12 seconds”, etc.) elapses (that is, in a case where the user does not press any of the operation keys until the set illumination time elapses), in step S39, the control unit 41 controls the main display 17 to set the lighting state of the main display 17 from the full lighting state to the partial state. With this configuration, the lighting state of the main display 17 is set in the darker lighting state. For example, as illustrated in a display screen 52-c of FIG. 7, while the icons α to γ are displayed in the display area 1 of the main display 17, the lighting state of the main display 17 is set from the full lighting state to the partial state.

In step S40, by using the clock circuit 47, the control unit 41 determines whether 5 seconds elapse after the lighting state of the main display 17 is set in the full lighting state. The processing stands by until it is determined that 5 seconds elapse after the lighting state of the main display 17 is set in the full lighting state. It should be noted that in the determination processing in step S40, the embodiment of the present invention is not limited to a case in which the control unit 41 determines whether 5 seconds elapse after the full lighting state is set, but the determination may be performed as to whether a predetermined period of time (for example, 5 seconds, etc.), which is previously set, elapses after the elapse of the illumination time.

In step S40, it is determined that 5 seconds elapse after the lighting state of the main display 17 is set in the full lighting state, in step S41, the control unit 41 controls the main display 17 to delete the icons related to the field intensity and the battery remaining amount (the display of the icons) in synchronism with the elapse of 5 seconds since the lighting state of the main display 17 is set in the full lighting state after the lighting state of the main display 17 is transited from the full lighting state to the partial state.

For example, as illustrated in the display screen 52-c of FIG. 7, after the lighting state of the main display 17 is transited from the full lighting state to the partial state, in synchronism with the elapse of 5 seconds since the lighting state of the main display 17 is set in the full lighting state, the icon α related to the field intensity, the icon β related to the mail, and the icon γ related to the battery remaining amount (the display of the icons) displayed in the display area 1 on the display screen 52-c of FIG. 7 in the partial state are deleted.

After that, the processing is advanced to step S42, and the processing in step S42 and subsequent steps is repeatedly executed.

With this configuration, even in a case where the illumination time is set as a time shorter than 5 seconds (for example, 0 to 4 seconds) in accordance with the preference of the user, the lighting state of the main display 17 is set in the partial state in the short period of time preferred by the user, and also it is possible to carry out such a control that the icons related to the field intensity and the battery remaining amount are not deleted at least 5 seconds Therefore, in such a case, after the lighting state of the main display 17 is transited from the full lighting state to the partial state, in synchronism with the elapse of 5 seconds since the lighting state of the main display 17 is set in the full lighting state, it is possible to delete the icons related to the field intensity and the battery remaining amount (the display of the icons). As a result, irrespective of the length of the illumination time, it is possible to improve the usability while the degradation of the display configured by using the organic EL (the main display 17 and the sub-display 21) is suppressed.

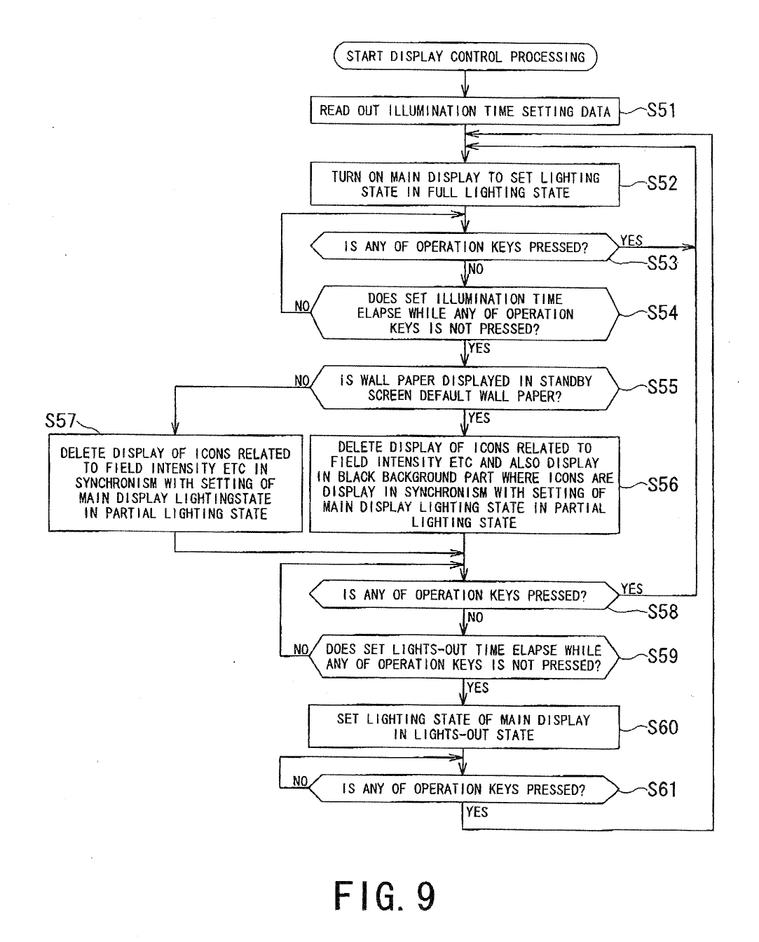

Incidentally, in a case the image displayed as the background on the standby screen is a default wall paper other than the wall paper arbitrarily set by the user, in synchronism with the setting of the lighting state of the main display in the partial state, not only the display of the icons related to the field intensity and the like is deleted, but also the background part where the icons related to the field intensity and the like are displayed is deleted, and the background part may be displayed in black (that is, the lighting state of the main display 17 corresponding to the background part may be partially (for example, in a rectangular shape manner, etc., and of course, the shape can be arbitrarily chosen)) set in the lights-out state (in black). The display control processing in this case is illustrated in a flowchart of FIG. 9. It should be noted that the processing in steps S51 to S54 and steps S57 to 561 in FIG. 9 is basically similar to that in steps S11 to S19 in FIG. 6, and a description thereof will be omitted to avoid the repetition.

In step S55, the control unit 41 determines whether the wall paper displayed in the standby screen of the main display 17 is a default wall paper (that is, the displayed wall paper is not the wall paper related to the image arbitrarily obtained by the user but is the specified wall paper previously stored in the storage unit 42). In step S55, in a case where it is determined that the wall paper displayed in the standby screen of the main display 17 is the default wall paper, in step S56, the control unit 41 controls the main display 17 to set the lighting state of the main display 17 from the full lighting state to the partial state. Also, in synchronism with this transition to the partial state, the icons related to the field intensity and the battery remaining amount (the display of the icons) are deleted, and at the same time, the background part where the icons are displayed is displayed in black. On the other hand, in a case where it is determined that the wall paper displayed in the standby screen of the main display 17 is not the default wall paper (that is, in a case where it is determined that the displayed wall paper is the wall paper related to the image arbitrarily obtained by the user), the processing is advanced to step S57. In step S57, only the icons related to the field intensity and the battery remaining amount (the display of the icons) are deleted.

With this configuration, the partial display is carried out in black with which the power consumption can be minimized when the image is displayed by using the organic EL. Thus, while the degradation of the display configured by using the organic EL (the main display 17 and the sub-display 21) is suppressed and the power consumption the display configured by using the organic EL is suppressed, it is possible to improve the usability. Of course, a gray scale close to black may be used instead of black.

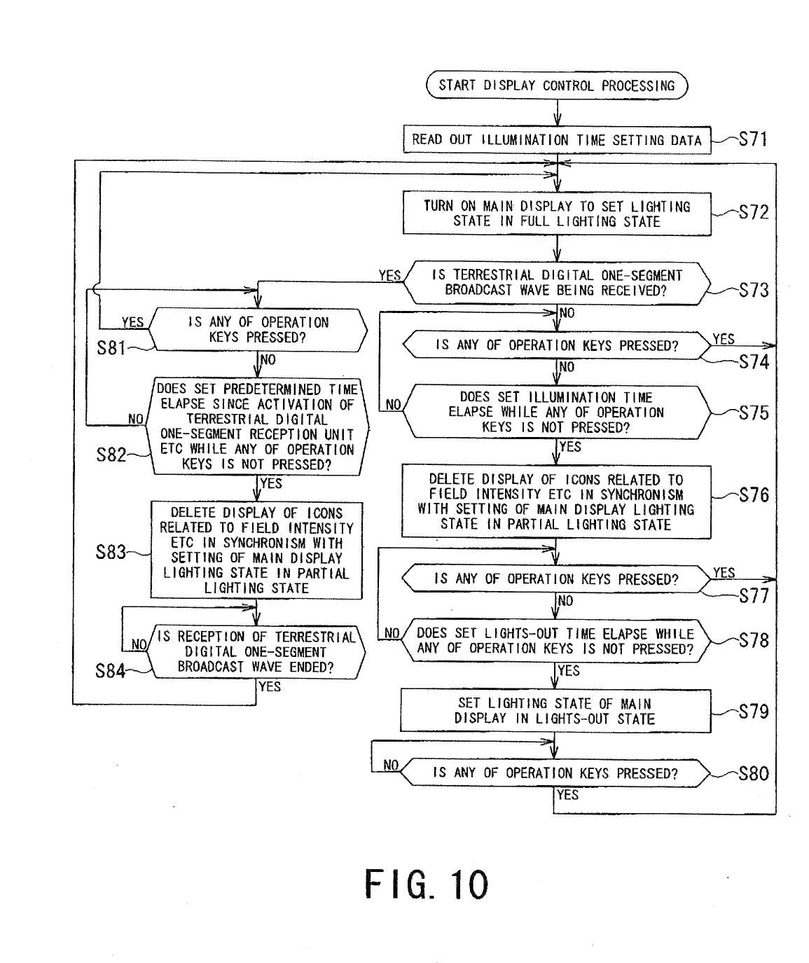

In addition, in a case where the terrestrial digital one-segment broadcast wave is received by the cellular phone 1 and a program based on the received terrestrial digital one-segment broadcast wave is displayed, the lighting state of the main display 17 cannot be set in the partial state in the course of the program view. Thus, in the display control processing in FIG. 6, the display of the icons related to the field intensity and the like cannot be deleted, and burning sticking (degradation) of pixels due to the display of the icons is caused. In view of the above, for example, as illustrated in a flowchart of FIG. 10, in step S73, the control unit 41 activates the terrestrial digital one-segment receiver 48 to determine whether the terrestrial digital one-segment broadcast wave is being received from a broadcasting station which is not shown. In a case where it is determined that the terrestrial digital one-segment broadcast wave is being received from a broadcasting station which is not shown, in step S81, the control unit 41 monitors the operation key 14 to determine whether the user presses any of the operation keys 14. In step S81, in a case where it is determined that the user presses any of the operation keys 14, the process is returned to step S72. In step S72, the lighting state of the main display 17 is kept in the full lighting state. On the other hand, in step S81, in a case where it is determined that the user does not press any of the operation keys 14, in step 382, the control unit 41 determines whether a predetermined period of time which is previously set (for example, 5 seconds, etc.) elapse after the terrestrial digital one-segment receiver 48 is activated or after the reception is once interrupted (for example, 5 seconds, etc.), or after the terrestrial digital one-segment broadcast wave is actually displayed on the main display 17. In step S82, in a case where it is determined that the predetermined time which is previously set elapses after the activation of the terrestrial digital one-segment receiver 48 or the like, in step S83, the control unit 41 controls the main display 17 to delete the icons related to the field intensity and the battery remaining amount (the display of the icons) while the lighting state of the main display 17 is kept in the full lighting state. Then, in step S84, the control unit 41 determines whether the end of the reception of the terrestrial digital one-segment broadcast wave is instructed as the user operates the operation keys and the reception of 14 the terrestrial digital one-segment broadcast wave is ended. In a case where it is determined that the reception of the terrestrial digital one-segment broadcast wave is ended, the processing is returned to step S72, and the processing in step S72 and subsequent steps is repeatedly executed. On the other hand, in step S82, in a case where it is determined that the predetermined time which is previously set does not elapse after the activation of the terrestrial digital one-segment receiver 48 or the like, the processing is returned to step S81, and the processing in step S81 and subsequent steps is repeatedly executed. It should be noted that the processing in other steps in FIG. 10 is basically similar to that of FIG. 6.

With this configuration, even in a case where the lighting state of the main display 17 cannot be set in the partial state in the course of the view of the terrestrial digital one-segment broadcast wave, while the degradation of the display configured by using the organic EL (the main display 17 and the sub-display 21) is suppressed, it is possible to improve the usability.

It should be noted that when the terrestrial digital one-segment broadcast wave is received by the cellular phone 1 and a program based on the received terrestrial digital one-segment broadcast wave is displayed, in a case where the terrestrial digital one-segment receiver 48 is automatically activated at a timer view starting time which is previously set to carry out the timer view, the cellular phone 1 activates the terrestrial digital one-segment receiver 48 at a time slightly before the timer view starting time (for example, 1 minute before, or the like). For that reason, in the determination processing in step S82 of FIG. 10, if the determination is performed simply on the basis of elapse of the predetermined time since the activation of the terrestrial digital one-segment receiver 48, before the timer view starting time, the display of the icons related to the field intensity and the like is deleted.

In view of the above, in the case of the timer view of the terrestrial digital one-segment broadcast wave, the determination may be performed on the basis of elapse of a predetermined time longer than the predetermined time used for the normal view or the like (for example, 1 minute 5 seconds, or the like). With this configuration, even in a case where the timer view of the terrestrial digital one-segment broadcast wave is carried out, while the degradation of the display using the organic EL (the main display 17 and the sub-display 21) is suppressed, it is possible to improve the usability.

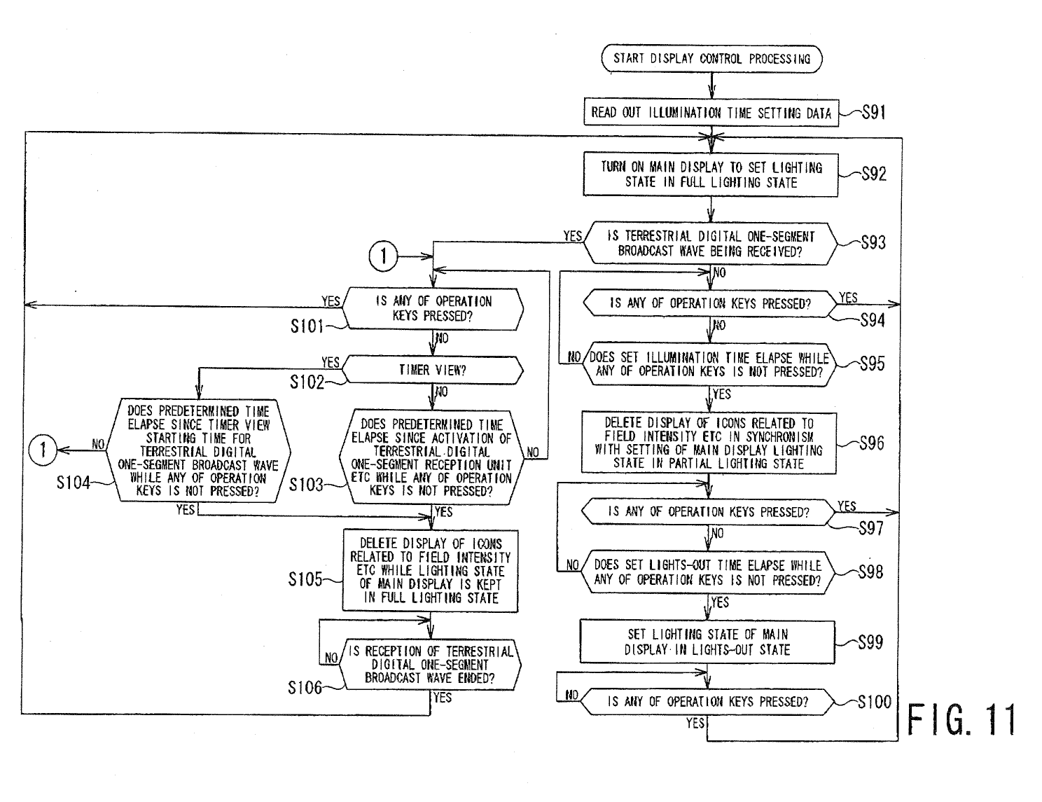

Of course, other than the above-mentioned configurations, for example, as illustrated in a flowchart of FIG. 11, in step S102, the control unit 41 determines whether this is the timer view using the terrestrial digital one-segment receiver 48. In step S102, in a case where the control unit 41 determines that this is the timer view using the terrestrial digital one-segment receiver 48, in step S104, the control unit 41 determines whether a predetermined time (for example, 5 seconds, etc.) elapses form the timer view starting time for the terrestrial digital one-segment broadcast wave while any of the operation keys 14 is not pressed. Then, in step S104, it is determined that the predetermined time elapses after the timer view starting time for the terrestrial digital one-segment broadcast wave while any of the operation keys 14 is not pressed, in step S105, the control unit 41 may control the main display 17 to delete the icons related to the field intensity and the battery remaining amount (the display of the icons) while the lighting state of the main display 17 is kept in the full lighting state. It should be noted that the processing in other steps in FIG. 11 is basically similar to that of FIG. 10. Also, this “timer view” also includes a case in which the terrestrial digital one-segment receiver 48 is automatically activated at a timer record starting time due to a timer record setting, and a video is displayed on the main display 17 along with the recording.

It should be noted that according to the embodiments of the present invention, the present invention is not limited to the terrestrial digital one-segment broadcast wave but also may be applied, for example, to the terrestrial digital three-segment radio broadcast wave.

It should be noted that in addition to the cellular phone 1, the present invention can also be applied to other information processing apparatuses such as a PDA (Personal Digital Assistant), a personal computer, a portable game player, a portable music player, and a portable video player.

Also, the series of processings described according to the embodiment of the present invention can be executed by using software but also executed by using hardware.

Furthermore, according to the embodiments of the present invention, such a processing example has been described that the steps of the flowcharts are processed in a time series manner in the stated order, but the present invention also encompasses a processing in which the steps are not necessarily processed in the time series manner and the steps are processed in a parallel manner or individually processed.

What is claimed is:

1. An information processing apparatus, comprising:
a display unit which is configured by an organic electronic luminescent including a light emitting layer and configured to display at least one piece of instruction information in a first display area of a standby screen;
a setting unit configured to set an illumination time which is a time taken for setting a lighting state of the display unit from a first state to a second state;
a determination unit configured to determine whether the illumination time set by the setting unit elapses after the lighting state of the display unit is set in the first state; and
a display control unit configured to set the lighting state of the display unit from the first state to the second state and control to delete the display of the instruction information displayed in the first display area by the display unit in a case where the determination unit determines that the illumination time set by the setting unit elapses after the lighting state of the display unit is set in the first state.

2. The information processing apparatus according to claim 1, wherein the first state is a full lighting state, and the second state is a partial state.

3. The information processing apparatus according to claim 1, wherein in a case where the illumination time is shorter than a reference time, when the determination unit determines that the illumination time elapses after the lighting state of the display unit is set in the first state, the display control unit sets the lighting state of the display unit from the first state to the second state, and controls to delete the display of the instruction information displayed in the first display area over an elapse of a predetermined time after the lighting state is transited from the first state to the second state.

4. The information processing apparatus according to claim 2, wherein in a case where the illumination time is shorter than a reference time, when the determination unit determines that the illumination time elapses after the lighting state of the display unit is set in the first state, the display control unit sets the lighting state of the display unit from the first state to the second state, and controls to delete the display of the instruction information displayed in the first display area over an elapse of a predetermined time after the lighting state is transited from the first state to the second state.

5. The information processing apparatus according to claim 1, wherein the instruction information includes icons or pictograms related to at least a field intensity, a mail, and a battery remaining amount.

6. The information processing apparatus according to claim 2, wherein the instruction information includes icons or pictograms related to at least a field intensity, a mail, and a battery remaining amount.

7. The information processing apparatus according to claim 1, wherein in a case where an image other than the predetermined wall paper is displayed on the standby screen, the display control unit controls to delete the display of the instruction information displayed in the first display area along with the transition to the second state and display a background part, where the instruction information is displayed, in a predetermined color.

8. The information processing apparatus according to claim 7, wherein in a case where a predetermined wall paper is displayed on the standby screen, the display control unit controls to delete the display of the instruction information displayed in the first display area along with the transition to the second state.

9. The information processing apparatus according to claim 7, wherein the predetermined wall paper displayed on the standby screen is a default wall paper.

10. The information processing apparatus according to claim 7, wherein power consumption in a case where the display unit displays the background part in the predetermined color is smaller than power consumption in a case, where the display unit displays the background part in a color according to the predetermined wall paper.

11. The information processing apparatus according to claim 10, wherein the predetermined color is black or a color by a gray scale.

12. The information processing apparatus according to claim 2, wherein in a case where an image other than the predetermined wall paper is displayed on the standby screen, the display control unit controls to delete the display of the instruction information displayed in the first display area along with the transition to the second state and display a background part, where the instruction information is displayed, in a predetermined color.

13. The information processing apparatus according to claim 12, wherein in a case where a predetermined wall paper is displayed on the standby screen, the display control unit controls to delete the display of the instruction information displayed in the first display area along with the transition to the second state.

14. The information processing apparatus according to claim 12, wherein the predetermined wall paper displayed on the standby screen is a default wall paper.

15. The information processing apparatus according to claim 12, wherein power consumption in a case where the display unit displays the background part in the predetermined color is smaller than power consumption in a case where the display unit displays the background part in a color according to the predetermined wall paper.

16. The information processing apparatus according to claim 15, wherein the predetermined color is black or a color by a gray scale.

17. The information processing apparatus according to claim 1, wherein in a case where the information processing apparatus is receiving a broadcast wave transmitted from a broadcasting station, the display control unit controls to delete the display of the instruction information displayed in the first display area by the display unit over an elapse of a predetermined time while the lighting state of the display unit is kept in the first state.

18. The information processing apparatus according to claim 17, wherein the display control unit controls to delete the display of the instruction information displayed in the first display area by the display unit over an elapse of a predetermined time after the activation of the terrestrial digital one-segment reception processing.

19. The information processing apparatus according to claim 17, wherein in a case where the information processing apparatus is receiving the broadcast wave transmitted from the broadcasting station on an occasion other than a timer view, the display control unit controls to delete the display of the instruction information displayed in the first display area by the display unit over an elapse of a first predetermined time, and in a case where the information processing apparatus is receiving the broadcast wave transmitted from the broadcasting station on the timer view, the display control unit controls to delete the display of the instruction information displayed in the first display area by the display unit over an elapse of a second predetermined time which is different from the first predetermined time.
